(19) United States
(12) Patent Application Publication
(10) Pub. No.: US 2017/0279648 A1
(43) Pub. Date: Sep. 28, 2017

(54) APPARATUS AND METHOD FOR REDUCING PEAK TO AVERAGE POWER RATIO (PAPR) IN LAYER DIVISION MULTIPLEXING (LDM) SYSTEM

(71) Applicant: Electronics and Telecommunications Research Institute, Daejeon (KR)

(72) Inventors: Jin Hyuk SONG, Daejeon (KR); Sang Jung RA, Daejeon (KR); Jae Hwui BAE, Daejeon (KR); Dong Joon CHOI, Daejeon (KR); Nam Ho HUR, Sejong-si (KR)

(21) Appl. No.: 15/403,738

(22) Filed: Jan. 11, 2017

(30) Foreign Application Priority Data
Mar. 24, 2016 (KR) 10-2016-0035075

(51) Int. Cl. H04L 27/26

(52) U.S. Cl. CPC H04L 27/2621

(57) ABSTRACT

Disclosed is a an apparatus for reducing a reducing a peak to average power ratio (PAPR) for layer division multiplexing (LDM) in an orthogonal frequency division multiplexing (OFDM) system, the apparatus may include a peak remover configured to detect a peak power value of a subcarrier signal that is input and generate a peak removal signal that decreases the detected peak power value, and a processor configured to perform constellation remapping on a first signal generated by combining the subcarrier signal and the peak removal signal and then generate a second signal into which additional data is inserted.

### CROSS-REFERENCE TO RELATED APPLICATION(S)

This application claims the priority benefit of Korean Patent Application No. 10-2016-0035075 filed on Mar. 24, 2016, in the Korean Intellectual Property Office, the disclosure of which is incorporated herein by reference for all purposes.

### BACKGROUND

1. Field

One or more example embodiments relate to layer division multiplexing (LDM) technology based on an orthogonal frequency division multiplexing (OFDM) system, and more particularly, to an apparatus and method for reducing a peak to average power ratio (PAPR) for LDM in an OFDM system and minimizing a decrease of a transmission rate through additional data transmission.

2. Description of Related Art

Recently, layer division multiplexing (LDM) technology as next generation broadcasting technology that provides fixed ultra high definition (UHD) and mobile high definition (HD) broadcasts using a lowest frequency has been receiving attention. LDM technology based on orthogonal frequency division multiplexing (OFDM) may enhance mobile reception performance by extending a service range, but there is a limitation in this regard in that a peak to average power ratio (PAPR) increases because subcarriers overlap in a phase condition.

In an OFDM system, a tone reservation scheme is used as a method of reducing a PAPR. The tone reservation scheme may insert a predetermined tone signal into a predetermined subcarrier signal, and then measure the PAPR by combining the subcarrier signal and an original signal. The tone reservation scheme may change the combined signal and go through the same process again, and then may finally transmit transmission data and the tone signal having an optimal PAPR. When the tone reservation scheme is used, data transmission efficiency may be reduced as performance for reducing a PAPR is enhanced, because a tone reservation scheme utilizes a predetermined subcarrier signal. To compensate for such limitation, technology for minimizing a decrease of a data transmission rate while decreasing a PAPR may be required.

### SUMMARY

According to an aspect, there is provided an apparatus for reducing a peak to average power ratio (PAPR) for layer division multiplexing (LDM) in an orthogonal frequency division multiplexing (OFDM) system, the apparatus including a peak remover configured to detect a peak power value of a subcarrier signal that is input and generate a peak removal signal that decreases the detected peak power value, and a processor configured to perform constellation remapping on a first signal generated by combining the subcarrier signal and the peak removal signal and then generate a second signal into which additional data is inserted.

The subcarrier signal may be a tone reservation subcarrier signal.

The peak remover may be configured to calculate a PAPR of the first signal and repeatedly generate the peak removal signal until the calculated PAPR is less than or equal to a predetermined threshold.

The peak remover may be configured to limit an amplitude of the detected peak power value with respect to the subcarrier signal and generate the peak removal signal by performing scaling and phase rotating.

As an example, which is not intended to be limiting, the apparatus may further include a preprocessor configured to perform a fast Fourier transform (FFT) and parallel to serial conversion on the subcarrier signal.

The processor may be configured to perform a fast Fourier transform (FFT) on the first signal and then perform the constellation remapping.

The processor may be configured to insert the additional data into the first signal on which the constellation remapping is performed based on a predetermined insertion level.

The apparatus may further include a transmitter configured to transmit a third signal generated by performing an inverse fast Fourier transform (IFFT) on the second signal.

According to another aspect, there is provided a method of reducing a peak to average power ratio (PAPR) for layer division multiplexing (LDM) in an orthogonal frequency division multiplexing (OFDM) system, the method including detecting a peak power value of a subcarrier signal that is input, generating a peak removal signal that decreases the detected peak power value, performing constellation remapping on a first signal generated by combining the subcarrier signal and the peak removal signal, and generating a second signal by inserting additional data into the first signal on which the constellation remapping is performed.

The subcarrier signal may be a tone reservation subcarrier signal.

The generating of the peak removal signal may include limiting an amplitude of the detected peak power value with respect to the subcarrier signal and generating the peak removal signal by performing scaling and phase rotating.

The generating of the peak removal signal may include calculating a PAPR of the first signal and repeatedly generating the peak removal signal until the calculated PAPR is less than or equal to a predetermined threshold.

The performing of the constellation remapping may include performing a fast Fourier transform (FFT) on the first signal and then performing the constellation remapping.

The generating of the second signal may include inserting the additional data into the first signal on which the constellation remapping is performed based on a predetermined insertion level.

The method may further include performing preprocessing to perform a fast Fourier transform (FFT) and parallel to serial conversion on the subcarrier signal.

The method may further include transmitting a third signal generated by performing an inverse fast Fourier transform (IFFT) on the second signal.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a diagram illustrating a data generating process using a layer division multiplexing (LDM) method according to an example embodiment;

FIG. 2 is a block diagram illustrating an apparatus for reducing a peak to average power ratio (PAPR) according to an example embodiment;

FIG. 3 is a diagram illustrating a general orthogonal frequency division multiplexing (OFDM) system to which a method of reducing a peak to average power ratio (PAPR) is applied according to an example embodiment;

FIG. 4 is a flowchart illustrating a process in which a peak removal signal is generated according to an example embodiment;

FIG. 5 is a diagram illustrating a constellation remapping process according to an example embodiment; and

FIG. 6 is a flowchart illustrating a method of reducing a peak to average power ratio (PAPR) according to an example embodiment.

### DETAILED DESCRIPTION

Hereinafter, some example embodiments will be described in detail with reference to the accompanying drawings. Regarding the reference numerals assigned to the elements in the drawings, it should be noted that the same elements will be designated by the same reference numerals, wherever possible, even though they are shown in different drawings. Also, in the description of embodiments, detailed description of well-known related structures or functions will be omitted when it is deemed that such description will cause ambiguous interpretation of the present disclosure.

It should be understood, however, that there is no intent to limit this disclosure to the particular example embodiments disclosed. On the contrary, example embodiments are to cover all modifications, equivalents, and alternatives falling within the scope of the example embodiments. Like numbers refer to like elements throughout the description of the figures.

In addition, terms such as first, second, A, B, (a), (b), and the like may be used herein to describe components. Each of these terminologies is not used to define an essence, order or sequence of a corresponding component but used merely to distinguish the corresponding component from other component(s). It should be noted that if it is described in the specification that one component is “connected”, “coupled”, or “joined” to another component, a third component may be “connected”, “coupled”, and “joined” between the first and second components, although the first component may be directly connected, coupled or joined to the second component.

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Various example embodiments will now be described more fully with reference to the accompanying drawings in which some example embodiments are shown. In the drawings, the thicknesses of layers and regions are exaggerated for clarity.

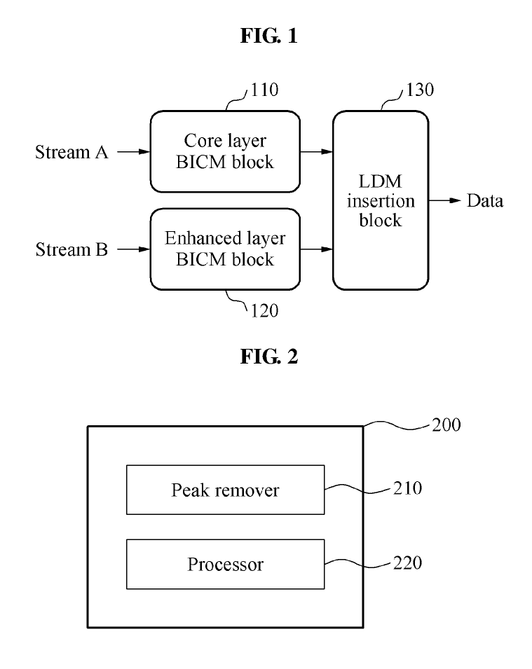

FIG. 1 is a diagram illustrating a data generating process using a layer division multiplexing (LDM) method according to an example embodiment.

The LDM method relates to technology for transmitting different signals by performing layer division, and the LDM method may transmit a core layer signal by adding an enhanced layer signal to the core layer signal.

FIG. 1 illustrates an example of a process in which data is generated using the LDM method. Different streams may be combined and generated based on a predetermined level after an interleaved coded modulation (BICM) is independently performed on each of the streams. For example, the BICM may be performed on a stream A through a core layer BICM block 110 and the BICM may be performed on a stream B through an enhanced layer BICM block 120, and then data may be generated by combining the stream A and the stream B based on a predetermined insertion level in an LDM insertion block 130. The data generated by the aforementioned method may be transmitted and allocated to a subcarrier signal.

FIG. 2 is a block diagram illustrating an apparatus for reducing a peak to average power ratio (PAPR) according to an example embodiment.

The apparatus for reducing a PAPR, hereinafter referred to as an apparatus 200, may reduce the PAPR for layer division multiplexing (LDM) and minimize a decrease of a transmission rate through the transmission of additional data. The apparatus 200 may include a preprocessor (not shown), a peak remover 210, a processor 220, and a transmitter (not shown). The preprocessor (not shown) and the transmitter (not shown) are optional components, and the preprocessor and the transmitter may be omitted in some examples.

The peak remover 210 detects a peak power value of a subcarrier signal that is input and generates a peak removal signal that decreases the detected peak power value. The subcarrier is a tone reservation subcarrier signal. The peak remover 210 calculates a PAPR of a first signal generated by combining the subcarrier signal and the peak removal signal and repeatedly generates the peak removal signal until the calculated PAPR is less than or equal to a predetermined threshold.

The peak remover 210 limits an amplitude of the detected peak power value with respect to the subcarrier signal and generates the peak removal signal by performing scaling and phase rotating.

The processor 220 performs constellation remapping on the first signal and then generates a second signal by inserting additional data into the first signal on which the constellation remapping is performed. The processor 220 may perform a fast Fourier transform (FFT) on the first signal to perform the constellation remapping.

The processor 220 may insert the additional data into the first signal on which the constellation remapping is performed based on a predetermined insertion level thereby compensating for the decrease of a data transmission rate.

Before the peak removal signal is generated, the preprocessor performs preprocessing on the input subcarrier signal to perform the FFT and parallel to serial conversion on the subcarrier signal.

The transmitter generates a third signal by performing an inverse fast Fourier transform (IFFT) on the second signal generated by the processor 220 and finally transmits the generated third signal.

The apparatus 200 may propose a method of increasing a PAPR using an allocated subcarrier signal for a tone reservation scheme while minimizing a decrease of a transmission rate through inserting additional data. In particular, the apparatus 200 may use a constellation remapping function and an additional data insertion function in addition to the general tone reservation scheme, such that an enhanced PAPR characteristic may be maintained and the decrease of a transmission rate caused by the tone reservation scheme may be minimized.

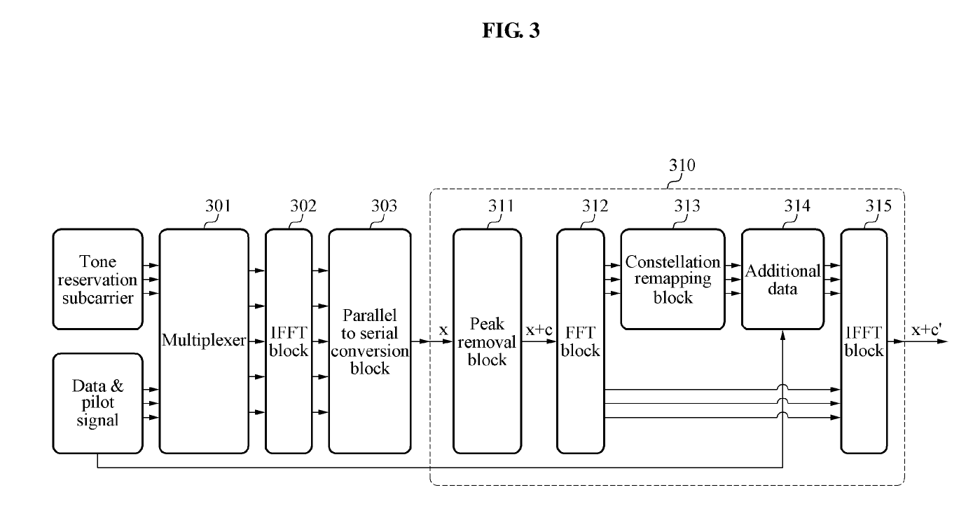

FIG. 3 is a diagram illustrating a general orthogonal frequency division multiplexing (OFDM) system to which a method of reducing a peak to average power ratio (PAPR) is applied according to an example embodiment.

As illustrated in FIG. 3, an apparatus for reducing a PAPR, hereinafter referred to as an apparatus 310, may be applied to an OFDM system using a tone reservation scheme.

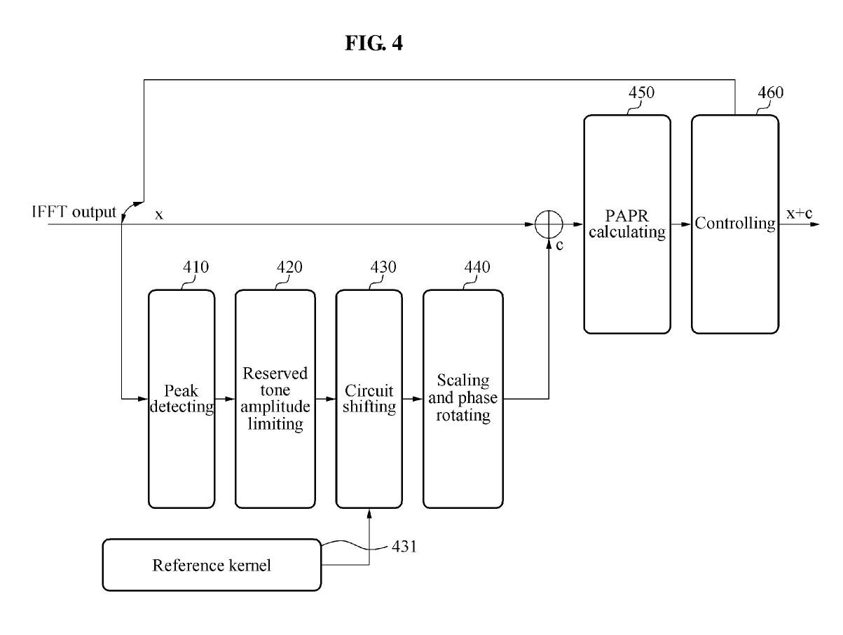

In FIG. 3, a tone reserved carrier, data, and a pilot signal may pass through a multiplexer 301, and an inverse fast Fourier transform (IFFT) by an IFFT block 302 and parallel to serial conversion by a parallel to serial conversion block 303 may be performed. Thus, a signal x generated by performing the aforementioned process may have a relatively high PAPR. To reduce the PAPR, the tone reservation scheme may be used through a peak removal block 311. Detailed descriptions of the general tone reservation scheme will be provided with reference to FIG. 4.

FIG. 4 is a flowchart illustrating a process in which a peak removal signal is generated according to an example embodiment. FIG. 4 illustrates a detailed configuration of the peak removal block 311 of FIG. 3.

The peak removal block 311 performs peak detecting 410 to detect a peak power value of an input signal x, and generates a peak removal signal c that decreases the detected peak power value. To generate the peak removal signal, reserved tone amplitude limiting 420, circuit shifting 430, and scaling and phase rotating 440 may be performed on the detected peak power value. In addition, the circuit shifting 430 may be performed using a reference kernel 431 in this process. Subsequently, the input signal x and the peak removal signal c are combined to generate a first signal, and PAPR calculating 450 is performed to calculate a PAPR of the first signal. The peak detecting 410, the reserved tone amplitude limiting 420, the circuit shifting 430, the scaling and phase rotating 440, and the PAPR calculating 450 may be repeatedly performed until the calculated PAPR is less than or equal to a predetermined threshold.

Based on a result of the PAPR calculating 450 that the PAPR is less than or equal to the threshold, a final peak removal signal x+c is generated and then the peak removal signal x+c is transmitted and combined with the input signal x through controlling 460 of a controller. Because the final peak removal signal x+c only has a value of an allocated tone reservation subcarrier signal, the final peak removal signal x+c may not interfere with data and a pilot signal.

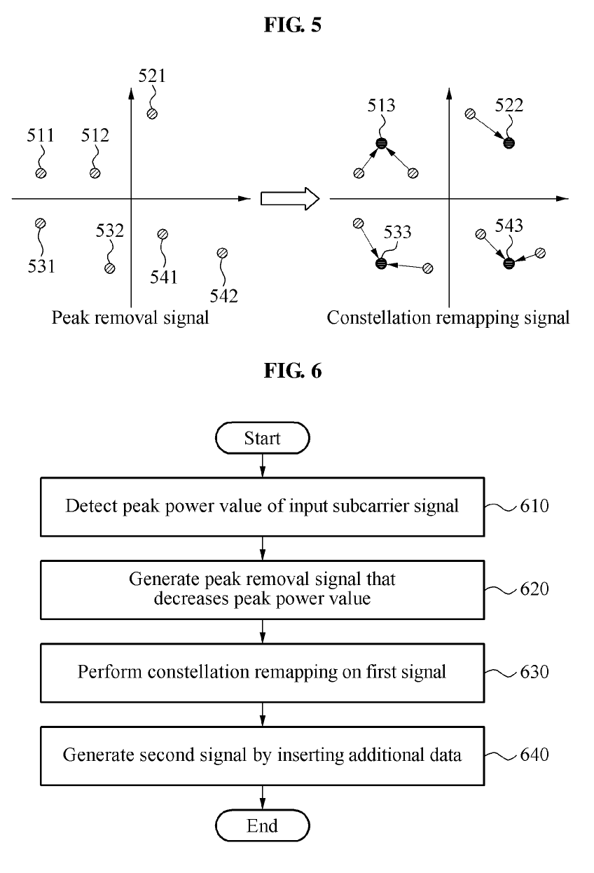

Referring back to FIG. 3, an FFT is performed, by an FFT block 312, on an output signal x+c of the peak removal block 311 and then constellation remapping is performed by a constellation remapping block 313. Detailed description of a process of the constellation remapping will be provided with reference to FIG. 5.

As illustrated in the left image of FIG. 5, FFT output signals may have different sizes and phases in a tone reservation subcarrier. Subsequently, the constellation remapping may be performed using the peak removal signal c and the constellation remapping may be expressed as shown in Equation 1.

$${C}_{re - mapping} = \{ \begin{matrix}\frac{1}{\sqrt{2}} ( 1 + 1 j ) , & if Re \{ C \} > 0 and Im \{ C \} > 0 \\ \frac{1}{\sqrt{2}} ( - 1 + 1 j ) , & if Re \{ C \} < 0 and Im \{ C \} > 0 \\ \frac{1}{\sqrt{2}} ( - 1 - 1 j ) , & if Re \{ C \} < 0 and Im \{ C \} < 0 \\ \frac{1}{\sqrt{2}} ( 1 - 1 j ) , & if Re \{ C \} > 0 and Im \{ C \} < 0\end{matrix} \qquad [ Equation 1 ]$$

As illustrated in the right image of FIG. 5, the constellation remapping may be performed on the FFT output signals using Equation 1. For example, FFT output signals 511, 512, 521, 531, 532, 541, and 542 may be distributed and have identical sizes and phases, but the constellation remapping may be performed such that the FFT output signals 511, 512, 521, 531, 532, 541, and 542 are changed to FFT output signals 513, 522, 533, and 543.

Because a signal on which the constellation remapping is performed is identical to a Quadrature Phase Shift Keying (QPSK) signal, additional data may be inserted.

Referring back to FIG. 3, the signal on which the constellation remapping is performed is identical to a signal to be transmitted through a core layer in a layer division multiplexing (LDM) system, and thus additional data 314 may be inserted. Similar to the process of generating data in the LDM system, the inserted additional data 314 may be combined with the signal on which the constellation remapping is performed based on a predetermined insertion level. The combined signal may be generated to be a final signal x+c′ by performing an inverse fast Fourier transform (IFFT) by an IFFT block 315, and then the final signal x+c′ may be transmitted.

FIG. 6 is a flowchart illustrating a method of reducing a peak to average power ratio (PAPR) according to an example embodiment.

An apparatus for reducing a PAPR may reduce the PAPR for an apparatus for layer division multiplexing (LDM) and minimize a decrease of a transmission rate through transmitting additional data.

In operation 610, a peak remover of the apparatus for reducing the PAPR detects a peak power value of a subcarrier signal that is input. The subcarrier signal is a tone reservation subcarrier signal. Prior to operation 610, a preprocessor of the apparatus for reducing the PAPR may perform preprocessing on the subcarrier signal to perform a fast Fourier transform (FFT) and parallel to serial conversion.

In operation 620, the peak remover generates a peak removal signal that decreases the peak power value detected in operation 610. The peak remover limits an amplitude of the detected peak power value with respect to the subcarrier signal and generates the peak removal signal by performing scaling and phase rotating.

In operation 620, the peak remover calculates a PAPR of a first signal generated by combining the subcarrier signal and the peak removal signal and then repeatedly generates the peak removal signal until the calculated PAPR is less than or equal to a predetermined threshold.

In operation 630, a processor of the apparatus for reducing the PAPR performs constellation remapping on the first signal. The processor may perform the FFT on the first signal to perform the constellation remapping in operation 630.

In operation 640, the processor generates a second signal by inserting additional data into the first signal on which the constellation remapping is performed in operation 630. In operation 640, the processor inserts the additional data into the first signal on which the constellation remapping is performed based on a predetermined insertion level.

Subsequent to operation 640, a transmitter of the apparatus for reducing the PAPR generates a third signal by performing an inverse fast Fourier transform (IFFT) on the second signal generated in operation 640, and finally transmits the generated third signal.

The components described in the exemplary embodiments of the present invention may be achieved by hardware components including at least one DSP (Digital Signal Processor), a processor, a controller, an ASIC (Application Specific Integrated Circuit), a programmable logic element such as an FPGA (Field Programmable Gate Array), other electronic devices, and combinations thereof. At least some of the functions or the processes described in the exemplary embodiments of the present invention may be achieved by software, and the software may be recorded on a recording medium. The components, the functions, and the processes described in the exemplary embodiments of the present invention may be achieved by a combination of hardware and software.

The units described herein may be implemented using hardware components, software components, or a combination thereof. For example, a processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums.

The method according to the above-described embodiments of the present invention may be recorded in non-transitory computer-readable media including program instructions to implement various operations embodied by a computer. The media may also include, alone or in combination with the program instructions, data files, data structures, and the like.

The program instructions recorded on the media may be those specially designed and constructed for the purposes of the embodiments, or they may be of the kind well-known and available to those having skill in the computer software arts. Examples of non-transitory computer-readable media include magnetic media such as hard disks, floppy disks, and magnetic tape; optical media such as CD ROM disks and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention, or vice versa.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An apparatus for reducing a peak to average power ratio (PAPR), the apparatus comprising:
a peak remover configured to detect a peak power value of a subcarrier signal that is input and generate a peak removal signal that decreases the detected peak power value; and
a processor configured to perform constellation remapping on a first signal generated by combining the subcarrier signal and the peak removal signal and then generate a second signal into which additional data is inserted.

2. The apparatus of claim 1, wherein the subcarrier signal is a tone reservation subcarrier signal.

3. The apparatus of claim 1, wherein the peak remover is configured to calculate a PAPR of the first signal and repeatedly generate the peak removal signal until the calculated PAPR is less than or equal to a predetermined threshold.

4. The apparatus of claim 1, wherein the peak remover is configured to limit an amplitude of the detected peak power value with respect to the subcarrier signal and generate the peak removal signal by performing scaling and phase rotating.

5. The apparatus of claim 1, further comprising:
a preprocessor configured to perform a fast Fourier transform (FFT) and parallel to serial conversion on the subcarrier signal.

6. The apparatus of claim 1, wherein the processor is configured to perform a fast Fourier transform (FFT) on the first signal and then perform the constellation remapping.

7. The apparatus of claim 1, wherein the processor is configured to insert the additional data into the first signal on which the constellation remapping is performed based on a predetermined insertion level.

8. The apparatus of claim 1, further comprising:
a transmitter configured to transmit a third signal generated by performing an inverse fast Fourier transform (IFFT) on the second signal.

9. A method of reducing a peak to average power ratio (PAPR), the method comprising:
detecting a peak power value of a subcarrier signal that is input;
generating a peak removal signal that decreases the detected peak power value;
performing constellation remapping on a first signal generated by combining the subcarrier signal and the peak removal signal; and
generating a second signal by inserting additional data into the first signal on which the constellation remapping is performed.

10. The method of claim 9, wherein the subcarrier signal is a tone reservation subcarrier signal.

11. The method of claim 9, wherein the generating of the peak removal signal comprises limiting an amplitude of the detected peak power value with respect to the subcarrier signal and generating the peak removal signal by performing scaling and phase rotating.

12. The method of claim 9, wherein the generating of the peak removal signal comprises calculating a PAPR of the first signal and repeatedly generating the peak removal signal until the calculated PAPR is less than or equal to a predetermined threshold.

13. The method of claim 9, wherein the performing of the constellation remapping comprises performing a fast Fourier transform (FFT) on the first signal and then performing the constellation remapping.

14. The method of claim 9, wherein the generating of the second signal comprises inserting the additional data into the first signal on which the constellation remapping is performed based on a predetermined insertion level.

15. The method of claim 9, further comprising:
performing preprocessing to perform a fast Fourier transform (FFT) and parallel to serial conversion on the subcarrier signal.

16. The method of claim 9, further comprising:
transmitting a third signal generated by performing an inverse fast Fourier transform (IFFT) on the second signal.
